(19) United States
(12) Patent Application Publication
(10) Pub. No.: US 2006/0211406 A1
(43) Pub. Date: Sep. 21, 2006

(54) Providing security for network subscribers

(75) Inventors: Sandor Szucs, Halasztelek (HU); Attila Molnar, God (HU)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/131,407

(22) Filed: May 18, 2005

(30) Foreign Application Priority Data
Mar. 17, 2005 (EP) 05005908.8

(51) Int. Cl. H04M 1/66

(52) U.S. Cl. 455/410; 455/466

(57) ABSTRACT

Messages are marked on the basis of whether they are originated in a home network or in a foreign network. Messages originated in the foreign network may be subjected to further filtering and may be put to ‘quarantine’ for further checking.

### FIELD OF THE INVENTION

The present invention relates to providing security for subscribers of a communications network, and to filtering messages.

### BACKGROUND OF THE INVENTION

Undesired messages such as spam messages disturb the subscribers of a communications network. In case of ‘normal spamming’ the originator of the spam messages itself is a subscriber of the home network and is well known. For example, the message is sent via a radio interface of a cellular network where authentication is done. Thus, the operator of the network should be able to control this ‘normal spamming’.

However, in case of ‘good spamming’ the originator is able to send a message on behalf of a home subscriber. For example, a message may be sent from a foreign network via SS7 (Signaling System No. 7) where no authentication is done. The originator may be able to send a mobile originated message or directly a mobile terminated message.

In case of ‘good spamming’ there are no useful CDRs (Call Detail Records) which means that a free sending of messages is possible and network resources can be used freely. In other words, a spam message is a fake message because it is created by a hacker. Appropriate actions for preventing such fake messages are the detection and rejection of such messages and a log generation for them.

For this purpose, a security layer may be inserted between a Transport layer and an Application layer. This solution is used in Internet Protocol Networks. Currently, security links are provided among SS7 network elements using MAPSec (Mobile Application Part Security). However, for this solution every network element which is connected to the global SS7 network should be able to support it. This means that nearly every network operator in the world should implement MAPSec. Presently, it is not possible to provide security links between SS7 network elements with a global MAPSec solution.

### SUMMARY OF THE INVENTION

It is therefore an object of the present invention to solve the above problems and to provide security for subscribers of a communications network.

Moreover, it is an object of the invention to protect a network against certain messages.

These objects are achieved by a method of providing security for subscribers according to claim 1 and a network entity according to claim 15.

Moreover, the above objects are achieved by a method of filtering messages according to claim 11 and a network entity according to claim 24.

The above objects are also achieved by a computer program product according to claim 12.

Further features of the present invention are defined in the dependent claims.

According to the invention, a message content can be secured locally inside a home PLMN (Public Land Mobile Network).

For example, if a “hacker” is able to access an SS7 network, he is able to create ‘MAP Forward_MO_SM’ or ‘Forward_MT_SM’ operations with a fake content and send it to anywhere in the world. According to the inventon, network operators are enabled to prevent their networks from such fake short messages and are enabled to prevent their subscribers from receiving such messages, too.

According to an embodiment of the invention, short messages are filtered on the basis of whether they are originated in a home network or in a foreign network. After filtering those short messages originated in the foreign network these messages may be put to ‘quarantine’ for further checking.

According to a further embodiment, the above filtering is done not just locally inside one network but also between several network operators. Thus, a basis is formed for a global level SMS (Short Message Service) spam preventing method.

### BRIEF DESCRIPTION OF THE DRAWINGS

FIG. 1 shows a schematic block diagram illustrating a network entity according to an embodiment of the present invention.

FIG. 2 shows flow diagrams illustrating a method of providing security to subscribers of a communications network according to an embodiment of the invention, which method comprises at least one of a procedure of detecting certain messages and a procedure of filtering messages.

FIG. 3 shows an implementation example of the present invention in a situation where a subscriber of a home network originates a short message.

FIG. 4 shows an implementation example of the present invention in a situation where a sender of a foreign network originates a mobile originated short message.

FIG. 5 shows an implementation example of the present invention in a situation where a sender of a foreign network originates a mobile terminated short message.

### DESCRIPTION OF THE INVENTION

In the following the present invention will be described by way of embodiments thereof taking into account the accompanying drawings.

The idea of the present invention is to mark a message created in a home network with an identifier, for example a unique identifier (which will be described later). Based on this identifier the network is able to differentiate home and foreign messages. In case of foreign messages the network may execute a further ‘multilevel’ filtering mechanism.

The above mentioned identifier of the messages may be used not just locally inside one network but also between several network operators. The formula which provides this identifier may contain one or more operator specific parameters so that the identifier is different operator by operator, i.e. is a unique identifier.

According to an implementation example of the invention (to be described later) ‘multilevel’ filtering is adopted to determine SMS (Short Message Service) spamming. First, it is checked in a first network element receiving a message, such as a V-MSC (Visited-Mobile Switching Center), IW-MSC (InterWorking-MSC), GW-MSC (GateWay-MSC) or SMSC (Short Message Service Center), whether the message is sent from an operator's own network. In this case, as mentioned above, a unique identifier or key is added to the message. There is no need for special precaution, and the message can be delivered to a B number (number of a receiver for which the message is intended).

However, if the message is received from a network other than the operator's own network, a special identifier is added to the message at the entry point, marking the message for further filtering at the SMSC. For the marked messages, the following steps may be executed:

level 1: checking the number of messages from the same source;

level 2: if number is found too high, checking what percentage of the contents of the messages is matching; and

level 3: if the contents are identical or similar, the message is sent to quarantine.

In the following, the general concept of the invention will be described by way of an embodiment thereof.

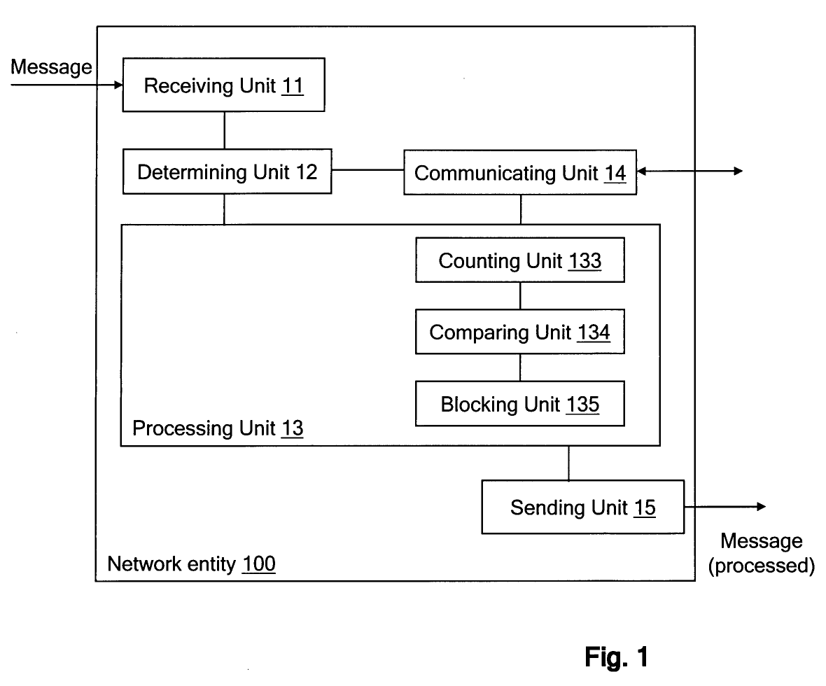

FIG. 1 shows a network entity 100 which receives messages and transmits messages which may have been processed by the network entity 100. According to an implementation example, the network entity 100 may be an MSC (Mobile Switching Center), SGSN (Serving GPRS (General Packet Radio Service) Support Node) or SMSC (Short Message Service Center). The network entity 100 may receive short messages originated by a sender subscribed to the network to which the network entity 100 belongs or by a sender of a foreign network. The sender may be a mobile terminal. In case of a sender of a foreign network, a message may be originated as mobile originated message or as mobile terminated message.

The network entity 100 comprises a receiving unit 11, a determining unit 12 and a processing unit 13 which may comprise a counting unit 133, a comparing unit 134 and a blocking unit 135. The network entity 100 may further comprise a communicating unit 14 and a sending unit 15.

According to another embodiment, the determining unit 12 may be part of the processing unit 13, and the receiving unit 11, the sending unit 15 and the communicating unit 14 may be implemented in a transceiver unit.

Moreover, according to a further embodiment, the counting unit 133, the comparing unit 134 and the blocking unit 135 may be separate from the processing unit 13 or may be part of another network entity such as a network entity running an application as described in the implementation example later on.

When the receiving unit 11 receives a message originated by a sender, the determining unit 12 determines an identifier of the message, wherein the identifier is associated with the sender. This determination may comprise generating and adding an identifier to the message (e.g. in case the network entity 100 is the first network element to receive the message) or generating and validating an identifier added to the message. Then, the processing unit 13 processes the message in accordance with the identifier.

The communicating unit 14 may communicate with a database (e.g. a HLR (Home Location Register) in the implementation example) for obtaining information about the sender, wherein the determining unit 12 may determine the identifier on the basis of the obtained information about the sender.

In case the identifier of the message is determined by the determining unit 12 to indicate that a network of the sender and a network in which the message is received, i.e. the network of the network entity 100, are different, the counting unit 133 may be instructed by the processing unit 13 to count a number of messages received from the same sender. If the number exceeds a threshold value, the comparing unit 134 is instructed to check whether the contents of the messages are similar, and if the contents are similar, the blocking unit 135 is instructed to block the message.

If the number does not exceed a threshold value or if the contents are not similar, the determining unit 12 may determine another identifier for the message, and the message can be routed to an intended receiver of the message. The newly determined identifier may be associated with the network of the network entity 100.

According to another embodiment in which the counting unit 133, the comparing unit 134 and the blocking unit 135 are part of another network entity separate from the network entity 100, the another network entity may comprise a determining unit for determining the another identifier.

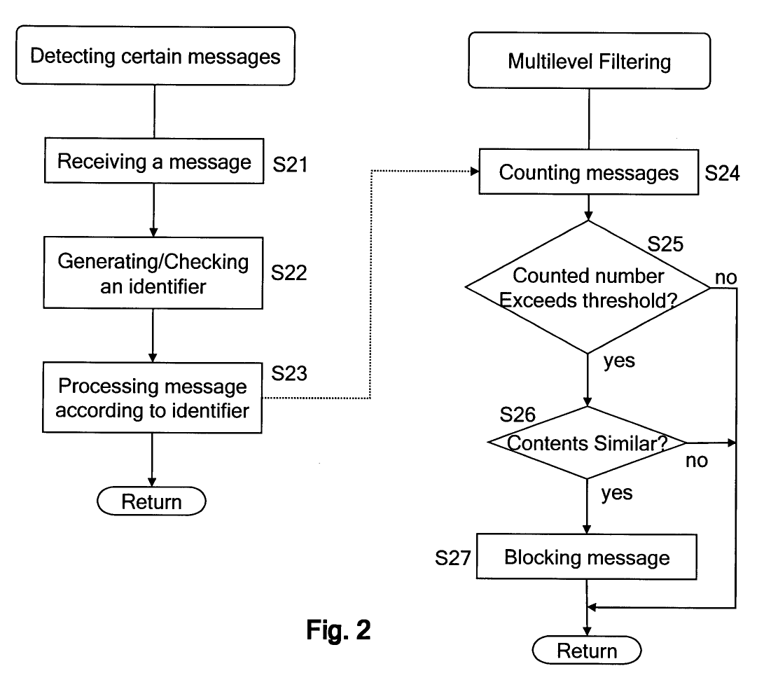

FIG. 2 shows flow diagrams illustrating methods which may be executed by the network entity 100.

The flow diagram on the left in FIG. 2 illustrates a method of detecting certain messages for providing security for subscribers of a communications network.

In step S21, a message originated by a sender is received. Then, an identifier of the message is determined, i.e. generated or checked in step S22, wherein the identifier is associated with the sender. Then step S23 follows in which the message is processed in accordance with the identifier. This processing may include the process of multilevel filtering shown on the right in FIG. 2. According to another embodiment, the process of multilevel filtering is performed independently of the process of detecting certain messages.

The processing step S23 may alternatively include forwarding the received message with the determined identifier towards an intended receiver of the message.

The process of detecting certain messages may further include a communicating step (not shown) of communicating with a database for obtaining information about the sender, wherein the identifier is determined on the basis of the information about the sender.

The identifier may indicate whether a network of the sender and a network in which the message is received are different. The identifier may also be network operator specific. Furthermore, the identifier may indicate whether the message relates to an originating or a terminating direction.

The process of multilevel filtering includes a counting step S24 in which a number of messages received from the same sender is counted. Then in step S25 it is determined whether the number exceeds a threshold value. If yes, in step S26 it is checked whether the contents of the messages are similar e.g. by comparing the contents of the messages. If the contents are similar (yes in step S26), in step S27 the messages are blocked.

In case the number does not exceed a threshold value (no in step S25) or if the contents are not similar (no in step S26), another identifier may be determined for the message. This may be done back in the process of detecting certain messages or in the process of multilevel filtering.

The counting step S24 may be performed if the identifier of the message indicates that a network of the sender and a network in which the message is received are different. Moreover, the counting step S24 may comprise a sorting step of sorting the messages on the basis of the identifier.

The process of detecting certain messages and the process of multilevel filtering may be implemented as computer program product for a computer, comprising software code portions for performing the steps S21 to S23 and/or S24 to S27. The computer program product may comprise a computer-readable medium on which the software code portions are stored. Alternatively, the computer program product may be directly loadable into an internal memory of the computer.

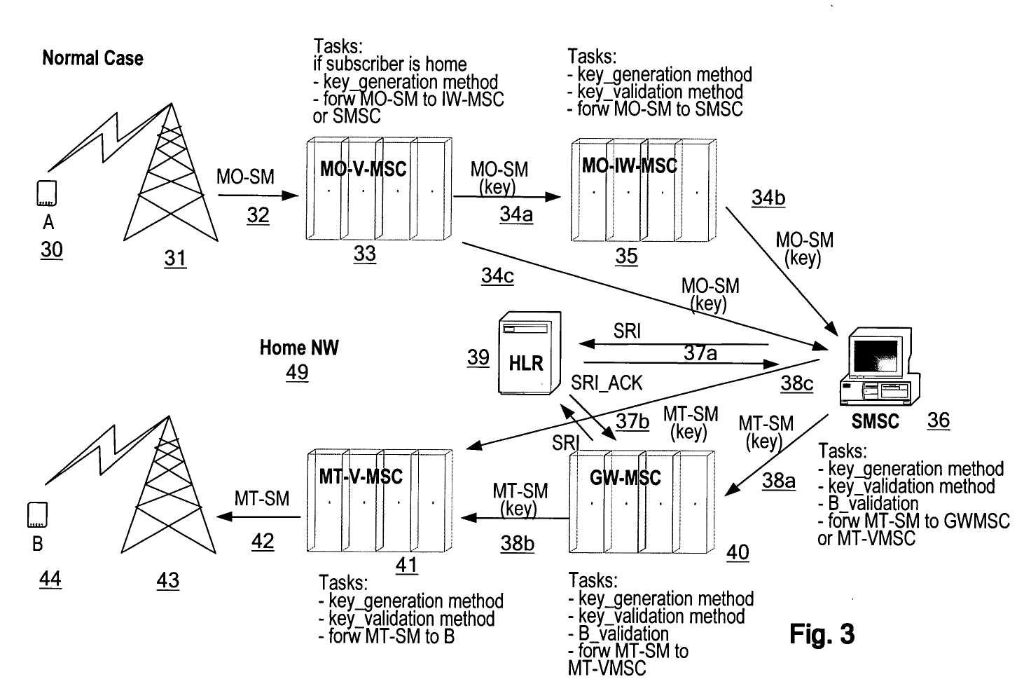

In the following, implementation examples of the invention will be described by referring to FIGS. 3 to 5. According to the implementation examples the invention is applied to a mobile SMS environment.

FIG. 3 shows an architecture of the mobile SMS environment of an operator or home network 49 and communications between entities of the home network 49 in accordance with a normal case in which a mobile sender or user A 30 originating a short message MO-SM 32 really is a subscriber of the home network 49. The home network or H-PLMN 49 comprises a home MO-VMSC 33 including VLRs (Visitor Location Registers, not shown), an MO-IWMSC 35, an SMSC 36, a GW-MSC 40, an MT-VMSC 41 and an HLR 39. The home network 49 may further include a TMSC (Transit Mobile Switching Center, not shown) for forwarding the MO-SM, which may be located between the MO-VMSC and the MO-IWMSC or between the GW-MSC and the MT-VMSC. The user A 30 accesses the home network 49 via an access network 31.

The MO-SM 32 is received by the home MO-VMSC (Mobile Originated-Visited Mobile Switching Center) 33 via an A interface from the access network 31. The MO-VMSC 33 recognizes that the user A 30 really is a subscriber of the home network, and performs a process key_generation in which a unique identifier or user specific key is generated which is added to the MO-SM 32. The MO-VMSC 33 can recognize that the user A 30 really is a subscriber of the home network because the MO-SM is received via the A interface after authentication from the home user A. Input parameters for a well defined formula for generating the key include a user specific number, a big prime number and an operator specific constant. The output parameter is a 6 digits long ID.

The operator specific key may be distributed and updated from time to time in case a higher security level is required. The key may be handled totally by the operator and distributed from time to time. This is useful for saving CPU load for calculating the key in every SM case. The key may be generated from time to time by a dedicated unit. Since there is an IP network besides an SS7 network the new key can be distributed to every network element similarly like “Network Time”.

The MO-VMSC 33 forwards the MO-SM with the generated identifier added to the MO-IWMSC (MO-InterWorking MSC) 35 (message MO-SM(key) 34a) in TCP/IP (Transport Control Protocol/Internet Protocol) connection case, or directly to the SMSC (Short Message Service Center) 36 in SS7 connection case (message MO-SM(key) 34c).

At the MO-IWMSC 35 (or in SS7 connection case at the SMSC 36), the message MO-SM(key) is received from the home MO-VMSC. The processes key_generation and key_validation (authentication) are performed in which the key generated at the MO-IWMSC 35 (or SMSC 36) is compared with the key added to the received message 34a (or 34c). In TCP/IP connection case the MO-IWMSC 35 forwards the authenticated message MO-SM(key) (message 34b) to the SMSC 36.

At the SMSC 36, depending on the key, the received message may be forwarded to an application (to be described later). As in the normal case the user A 30 is a subscriber of the home network 49, no further filtering of the message MO-SM(key) is needed.

Thus, the SMSC 36 formats the message MO-SM(key) into a mobile-terminated message MT-SM(key) and, in TCP/IP connection case, forwards the message MT-SM(key) to the GW-MSC (GateWay MSC) 40 (message 38a).

At the GW-MSC 40 an HLR (Home Location Register) inquiry (messages 37b) is performed using a request SRI (Send Routing Information) which is a MAP message sent by the GW-MSC to the HLR to request routing information in order to route the message towards a mobile subscriber. Moreover, the processes key_generation and key_validation (authentication) are performed. In addition, a process B_validation is executed in which the roaming status of a destination subscriber B 44 (i.e. home/inbound/outbound) is checked. In case it is detected that the destination subscriber B 44 is located in a foreign network, the GW-MSC 40 must remove the ‘key’ from the message MT-SM before forwarding it to the MT-VMSC 41 of the destination subscriber.

In the SS7 connection case, the above processes are performed by the SMSC 36, wherein the HLR inquiry is done in messages 37a.

The message MT-SM(key) is then forwarded to the MT-VMSC 41 of the destination subscriber (message 38b in TCP/IP connection case, or message 38c in SS7 connection case).

At the MT-VMSC 41 the processes key_generation and key_validation (authentication) are performed and the message MT-SM is forwarded to the destination subscriber B 44 via an access network 43 without the key (message 42).

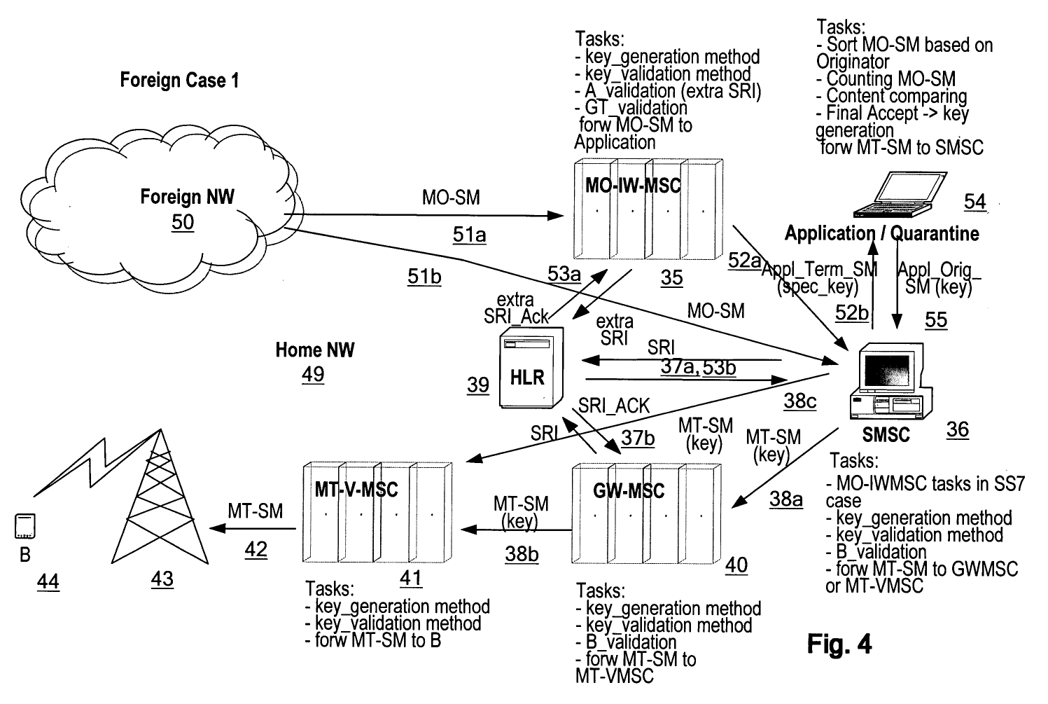

FIG. 4 shows communications between the entities of the home network 49 in accordance with a foreign case 1 in which a mobile sender or user A originating a short message MO-SM 51a/51b is located in a foreign network 50. In FIG. 4 same or similar entities and communications as shown in FIG. 3 are designated with the same reference numbers.

In case a message MO-SM 51a (TCP/IP connection case) sent from the foreign network 50 (e.g. from a foreign MO-VMSC) is received by the MO-IWMSC 35, the MO-IWMSC 35 performs the processes key_generation and key_validation (authentication). The MO-IWMSC receives an MO-SM always from MAP (Mobile Application Part). The MO-IWMSC knows that an MO-SM has been created in the home network if it contains a key.

As there is no key added to the message 51a, the MO-IWMSC 35 further performs a process A_validation for validating the sender subscriber A. In this process, firstly, CC (Country Code) and NDC (National Destination Code) of the sender are compared with CC and NDC of the home network 49. Secondly, an extra HLR inquiry (extra SRI messages 53a) should be initiated to fetch the A subscriber's real location (VLR (Visited Location Register) address). Then, a process GT_validation is performed which is a method of comparing the fetched VLR address with an arrived GT (Global Title) address included in the message 51a.

The sender A belongs to a foreign network in case the MO-SM does not contain any key and MSC CC and NDC of the sender A are different from those of the home network and HLR contains foreign VLR address of sender A.

In case it is determined by the above processes that the sender A of the message belongs to a foreign network, a special key spec_key is added to the message MO-SM and the message is forwarded to an application 54 as message Appl_Term_SM(spec_key) 52a. The message 52a may be forwarded to the application 54 via the SMSC 36 in a message 52b. Network entities which may run or be connected with the application comprise an application server which is connected to the SMSC via CIMD2, SMPP or UCP.

In the SS7 connection case the SMSC 36 receives the message MO-SM in a message 51b and performs the above-described tasks of the MO-IWMSC, including the HLR inquiry in messages 53b.

The application 54 represents a special queue and comprises a sorting and counting function of the received messages as well as a content comparing function, i.e. the multilevel filtering functions described with respect to FIG. 2. In case the application 54 finally accepts the message 52b (i.e. “no” in step S25 or S26 in FIG. 2), it performs the process key_generation and formats the received message into a mobile terminated short message MT-SM and forwards it with the generated key to the SMSC 36 as message Appl_Orig_SM(key) 55. The SMSC 36 then forwards the message 55 as message MT-SM(key) to the GW-MSC 40 (message 38a in the TCP/IP connection case) or to the MT-VMSC 41 (message 38c in the SS7 connection case).

In case the application 54 does not accept the message 52b, it quarantines it (step S27 in FIG. 2) e.g. for checking further details.

The following processes and communications of forwarding the message MT-SM(key) correspond to that performed in the normal case shown in FIG. 3 and thus their description is omitted.

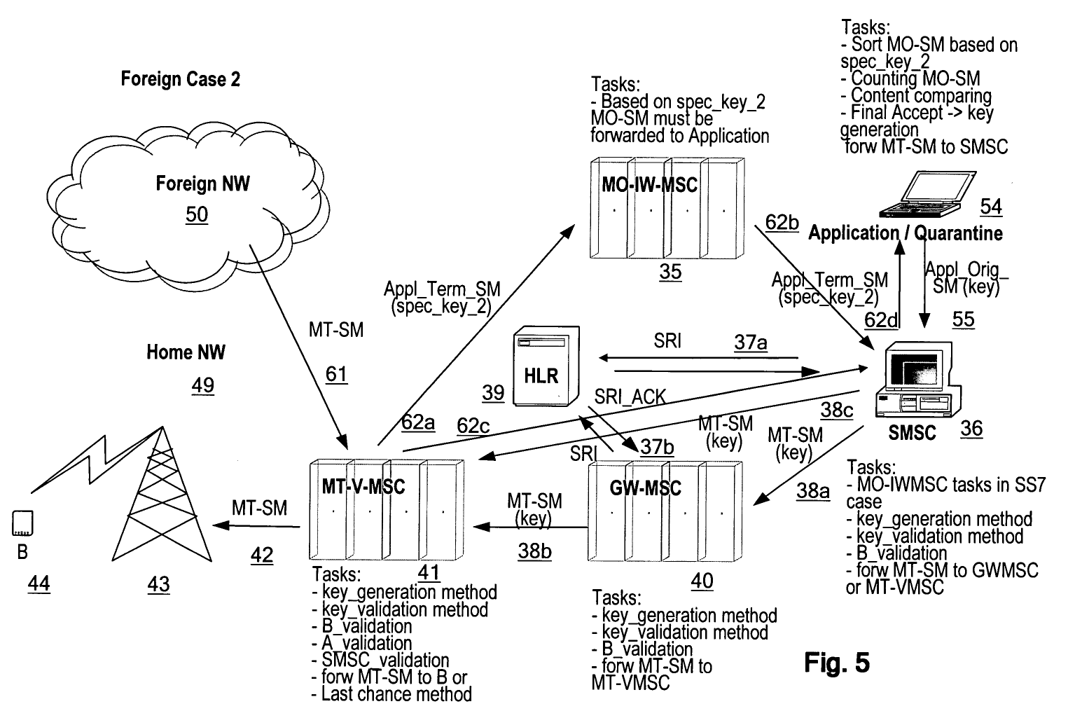

FIG. 5 shows communications between the entities of the home network 49 in accordance with a foreign case 2 in which a mobile sender or user A originating a mobile terminated short message MT-SM 61 is located in the foreign network 50. In FIG. 5 same or similar entities and communications as shown in FIG. 3 are designated with the same reference numbers.

When a message MT-SM 61 sent from the foreign network 50 is received by the MT-VMSC 41, the MT-VMSC 41 performs the processes key_generation and key_validation (authentication). As no key is added to the message 61, the MT-VMSC 41 further performs the processes B_validation and A_validation. In addition, the MT-VMSC 41 may perform a process SMSC_validation which is a method of comparing an arrived SMSC address included in the message 61 with a preconfigured SMSC address. If the user B 44 (inbound user) is a foreign user, the MT-VMSC can forward the message to the user B 44. In case the user B is a home user and the user A is still home, the SMSC validation is required and must be executed.

If it is detected in the above processes that the MT-SM does not contain any key but the originator pretends to be a subscriber A of the home network, then the MT-SM is detected to be a ‘fake’ message. Moreover, if the MT-SM is sent from the home SMSC then it is not possible that the MT-SM does not contain any key so in this case it is also a ‘fake’ message. In addition, if the originator pretends to be a home user but the SMSC address is not a home SMSC address, the MT-SM is a ‘fake’ message.

Having identified the message 61 as ‘fake’ message on the basis of the above processes, the MT-VMSC 41 may discard it by default or forward it to an SMSC ‘last chance’ method to collect it for further action. As ‘last chance method’ the MT-VMSC 41 turns the message back to the application 54 with a special key spec_key_2. In this process a message Appl_Term_SM(spec_key_2) is prepared from the received ‘fake’ MT-SM 61 and is forwarded to the application 54 via the MO-IWMSC 35 and the SMSC 36 in messages 62a, 62b and 62d in the TCP/IP connection case, or only via the SMSC 36 in messages 62c and 62d in the SS7 connection case, to collect these SMs in a special bin.

Based on the special key spec_key_2 included in the received message, the MO-IWMSC 35 or the SMSC 36 recognizes that the message has to be forwarded to the application 54.

The application 54 receiving the message 62d performs similar tasks as described with respect to the message 52b in FIG. 4. However, the application 54 may sort the message based on spec_key_2.

The following processes and communications of forwarding the message Appl_Orig_SM(key) or MT-SM(key) correspond to that performed in the normal case shown in FIG. 3 or in the foreign case shown in FIG. 4 and thus their description is omitted.

As can be understood from the foregoing description, the present invention provides a method and an apparatus for marking messages as to whether they are originated from the home or a foreign network. Moreover, the invention provides a method and an apparatus for multilevel filtering and quarantining certain messages such as messages originated from the foreign network.

According to the inventon, network operators are enabled to prevent their networks from fake short messages and are enabled to prevent their subscribers from receiving such messages, too.

According to an embodiment of the invention, short messages are filtered on the basis of whether they are originated in a home network or in a foreign network. After filtering those short messages originated in the foreign network these messages may be put to ‘quarantine’ for further checking.

According to a further embodiment, the above filtering is done not just locally inside one network but also between several network operators. Thus, a basis is formed for a global level SMS (Short Message Service) spam preventing method.

It is to be understood that the above description is illustrative of the invention and is not to be construed as limiting the invention. Various modifications and applications may occur to those skilled in the art without departing from the true spirit and scope of the invention as defined by the appended claims.

1. A method of providing security for subscribers of a communications network, the method comprising:
a receiving step of receiving a message originated by a sender;
a first determining step of determining an identifier of the message, wherein the identifier is associated with the sender; and
a processing step of processing the message in accordance with the identifier.

2. A method according to claim 1, comprising a communicating step of communicating with a database for obtaining information about the sender, wherein the identifier is determined based on the information about the sender.

3. A method according to claim 1, wherein the identifier indicates whether a first network of the sender and a second network in which the message is received are different.

4. A method according to claim 1, wherein the identifier is network operator specific.

5. A method according to claim 1, wherein the identifier indicates whether the message relates to an originating or a terminating direction.

6. A method according to claim 1, comprising:
an adding step of adding the identifier to the message.

7. A method according to claim 1, wherein the processing step comprises:
a counting step of counting a number of messages received from the sender;
a checking step of checking whether contents of the messages are similar if the number of messages exceeds a threshold value; and
a blocking step of, if the contents are similar, blocking the messages.

8. A method according to claim 7, wherein the processing step comprises:
a second determining step of, if the number of messages does not exceed the threshold value or if the contents are not similar, determining another identifier for the message.

9. A method according to claim 7, wherein the counting step comprises performing the counting step if the identifier of the message indicates that a first network of the sender and a second network in which the message is received are different.

10. A method according to claim 7, wherein the counting step comprises a sorting step of sorting the messages based on the identifier.

11. A method of filtering messages transmitted in a communications network, the method comprising:
a counting step of counting a number of messages received from a sender;
a checking step of checking whether contents of the messages are similar if the number of messages exceeds a threshold value; and
a blocking step of blocking the messages if the contents are similar.

12. A computer program embodied on a computer-readable medium, the computer program configured to control a computer to perform the steps of:
receiving a message originated by a sender;
determining an identifier of the message, wherein the identifier is associated with the sender; and
processing the message in accordance with an identifier.

13. The computer program according to claim 12, wherein the computer program includes software code portions stored on the computer-readable medium.

14. The computer program according to claim 12, wherein the computer program product is directly loadable into an internal memory of the computer.

15. A network entity for providing security for subscribers of a communications network, the network entity comprising:
a receiving unit for receiving a message originated by a sender;
a determining unit for determining an identifier of the message, wherein the identifier is associated with the sender; and
a processing unit for processing the message in accordance with the identifier.

16. A network entity according to claim 14, comprising an adding unit for adding the identifier to the message.

17. A network entity according to claim 15, comprising a communicating unit for communicating with a database for obtaining information about the sender, wherein the determining unit is configured to determine the identifier based on the information about the sender.

18. A network entity according to claim 15, comprising a counting unit, a comparing unit and a blocking unit, and wherein, if the identifier of the message is determined by the determining unit to indicate that a first network of the sender and a second network in which the message is received are different, the counting unit is configured to count a number of messages received from the sender, if the number of messages exceeds a threshold value, the comparing unit is configured to check whether the contents of the messages are similar, and if the contents are similar, the blocking unit is configured to block the message.

19. A network entity according to claim 18, wherein, if the number of messages does not exceed the threshold value or if the contents are not similar, the determining unit is configured to determine another identifier for the message.

20. A network entity according to claim 15, wherein the message comprises a short message and the network entity comprises a short message service center.

21. A network entity according to claim 15, wherein the message comprises a mobile originated message and the network entity comprises a mobile switching center.

22. A network entity according to claim 15, wherein the message comprises a mobile terminated message and the network entity comprises a mobile switching center.

23. A network entity according to claim 17, wherein the database comprises a home location register.

24. A network entity for filtering messages transmitted in a communications network, the network entity comprising:
a counting unit for counting a number of messages received from a sender;
a comparing unit for, if the number of messages exceeds a threshold value, checking whether contents of the messages are similar; and
a blocking unit for, if the contents are similar, blocking the messages.

25. A network entity according to claim 24, wherein the network entity comprises a short message service center.

26. A computer program embodied on a computer-readable medium, the computer program configured to control a computer to perform the steps of:
counting a number of messages received from a sender;
checking whether contents of the messages are similar if the number of messages exceeds a threshold value; and
blocking the messages if the contents are similar.

27. A system for providing security for subscribers, the system comprising:
receiving means for receiving a message originated by a sender;
determining means for determining an identifier of the message, wherein the identifier is associated with the sender; and
processing means for processing the message in accordance with the identifier.

28. A system for filtering messages, the system comprising:
counting means for counting a number of messages received from a sender;
checking means for checking whether contents of the messages are similar if the number of messages exceeds a threshold value; and
blocking means for blocking the messages if the contents are similar.
